(19) United States
(12) Patent Application Publication
(10) Pub. No.: US 2010/0081421 A1
(43) Pub. Date: Apr. 1, 2010

(54) METHOD FOR REMOTELY CONTROLLING USER DATA AND SYSTEM ADAPTED FOR THE METHOD

(75) Inventors: In Hyung JUNG, Gumi-si (KR); Sung Yong KIM, Gumi-si (KR); Tae Kyoung KIM, Daejeon Metropolitan City (KR); Sang Ha LEE, Daegu Metropolitan City (KR); Young Woo SON, Daegu Metropolitan City (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/570,543

(22) Filed: Sep. 30, 2009

(30) Foreign Application Priority Data
Oct. 1, 2008 (KR) 10-2008-0096496

(51) Int. Cl. H04M 3/00; H04W 4/00

(52) U.S. Cl. 455/419; 455/466

(57) ABSTRACT

A remote control system and method are disclosed that can remotely control user data stored in a remote portable terminal. The system includes a slave terminal, set in a remote control function, for storing the user data, and a master terminal for requesting the user data from the slave terminal and receiving it. The slave terminal authenticates the master terminal when the master terminal requests the user data therefrom, compresses the requested user data, according to the size of user data, during the authentication, and transmits the compressed user data to the master terminal. The slave terminal includes a memory for storing the user data, information regarding the master terminal, and a remote control password, a remote controlling unit for extracting the requested user data when the authenticated master terminal requests a transmission of the user data from the slave terminal, wherein the master terminal is authenticated by the stored remote control password, a compressing unit for compressing the user data by a compressing algorithm if the size of the user data is greater than a reference size, and a Radio Frequency (RF) communication unit for transmitting the user data to the master terminal.

### PRIORITY

This application claims the benefit under 35 U.S.C. §119(a) of a Korean patent application filed in the Korean Intellectual Property Office on Oct. 1, 2008 and assigned Serial No. 10-2008-0096496, the entire disclosure of which is hereby incorporated by reference.

### BACKGROUND OF THE INVENTION

1. Field of the Invention

The present invention relates to remote control. More particularly, the present invention relates to a method for remotely controlling user data stored in a portable terminal and a system adapted for the method.

2. Description of the Related Art

With the rapid development of information and technology, portable terminals have been also developed in terms of their technology and functions. Portable terminals can now provide a variety of functions, such as, a mobile communication function, a personal information management function, etc. Examples of the mobile communication function are a voice call and packet communication of text data or multimedia data. Examples of the personal information management function are a phone book management function and a daily schedule function. Users prefer portable terminals that employ recent technology and can provide a customized service. For example, users can store their personal information in the portable terminal. Therefore, portable terminals now become necessities in daily life.

As described above, conventional portable terminals have many advantages, such as portability and convenience, with the rapid development of their variety of functions. However, such advantages of the portable terminals may actually inconvenience the user. That is, if a user lost his/her portable terminal in which user data is stored, he/she may feel inconvenienced. In particular, if the person who picks up the portable terminal uses the portable terminal maliciously, such as disclosing the portable terminal owner's personal information or using charged services, the portable terminal loser may experience serious problems as a result. On the other hand, if a user cannot temporarily use his/her portable terminal, for example due to leaving the portable terminal at home, the user cannot use information stored in the portable terminal and thus may feel inconvenienced. Therefore, it is necessary to resolve the problems caused in cases where the user loses his/her portable terminal or leaves a place without carrying his/her portable terminal.

### SUMMARY OF THE INVENTION

An aspect of the present invention is to address at least the above-mentioned problems and/or disadvantages and to provide at least the advantages described below. Accordingly, an aspect of the present invention is to provide a method for remotely controlling user data stored in the portable terminal and a system adapted for the method.

In accordance with an aspect of the present invention, a method for remotely controlling user data is provided. The method includes setting a remote control function in a slave terminal, requesting, by a master terminal, the user data, stored in the slave terminal, from the slave terminal, authenticating, by the slave terminal, the master terminal, compressing, by the slave terminal, the user data requested by the master terminal, according to the size of the user data, and transmitting the compressed user data to the master terminal if the master terminal has been authenticated.

In accordance with another aspect of the present invention, a system for remotely controlling user data is provided. The system includes a slave terminal, set in a remote control function, for storing user data, and a master terminal for requesting the user data from the slave terminal and receiving it. The slave terminal authenticates the master terminal when the master terminal requests the user data therefrom, compresses the requested user data, according to the size of the user data, during the authentication, and transmits the compressed user data to the master terminal.

Other aspects, advantages, and salient features of the invention will become apparent to those skilled in the art from the following detailed description, which taken in conjunction with the annexed drawings, discloses exemplary embodiment of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 is a view illustrating a system for remotely controlling a portable terminal according to an exemplary embodiment of the present invention;

FIG. 2 is a schematic block diagram illustrating a portable terminal for remotely controlling user data, according to an exemplary embodiment of the present invention;

FIG. 3 is a signal flowchart describing a method for remotely controlling user data if a user does not carry his/her portable terminal, according to an exemplary embodiment of the present invention;

FIG. 4 is a signal flowchart describing a method for remotely controlling user data if a user lost his/her portable terminal, according to an exemplary embodiment of the present invention;

FIG. 5 is a flowchart describing a method for transmitting user data, according to an exemplary embodiment of the present invention;

FIGS. 6A, 6B and 6C are views illustrating a method for converting user data in a transmission format, according to an exemplary embodiment of the present invention; and

FIG. 7 illustrates display screens during a method for setting a remote control function, according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present invention relates to technology for controlling a portable terminal that a user has lost or does not carry by remotely acquiring or deleting user data from or in the portable terminal. In the following description, the technology for remotely controlling a portable terminal, according to the present invention, is described based on a mobile tracker function. The mobile tracker function refers to a function that transmits a message from a lost portable terminal to another electronic device, previously set, notifying that a Subscriber Identity Module (SIM) of the lost portable terminal is changed. In the following description, although the method for remotely controlling user data, according to an exemplary embodiment of the present invention, is described on the basis of the mobile tracker function, it should be understood that the present invention is not so limited. An exemplary method for remotely controlling user data, stored in a portable terminal, using a mobile tracker function will be described in more detail with reference to the accompanying drawings.

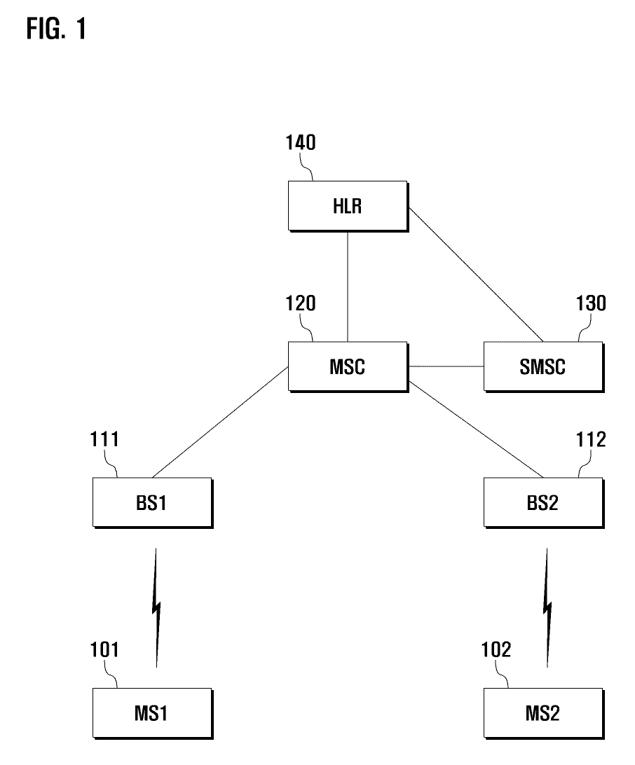

FIG. 1 is a view illustrating a system for remotely controlling a portable terminal according to an exemplary embodiment of the present invention. As shown in FIG. 1, the remote control method using a mobile tracker function allows a Short Message Service (SMS) message to be transmitted via a mobile communication network. The remote control method can perform a remote controlling operation using functions other than the mobile tracker function. The remote control method can process and transmit formats of messages other than the SMS messages, such as Multimedia Messaging Service (MMS) messages, emails, etc. Other formats of messages may be transmitted via networks other than the mobile communication network. If messages are transmitted via a network other than the mobile communication network, the structure of the system of FIG. 1 may be altered according to the network.

Referring to FIG. 1, a Mobile Station 1 (hereinafter called a ‘MS1’) 101 is a portable terminal that may be controlled by a remote control function. That is, the MS1 101 is a slave terminal. A Mobile Station 2 (hereinafter called a ‘MS2’) 102 is a terminal that can remotely control the MS1 101. That is, the MS2 102 is a master terminal. Base Station 1 (BS1) 111 and Base Station 2 (BS2) 112 manage the MS1 101 and MS2 102, respectively. If the MS1 101 and MS2 102 are located within one cell, i.e., the same cell, it means that the BS1 101 and BS2 102 are the same base station. That is, one cell is covered by only one base station. The BS1 111 and BS2 112 are connected to and communicate with the MS1 101 and MS2 102 via a wireless link, respectively. A Mobile Switching Center (MSC) 120 processes signals communicated between the BS1 111 and BS2 112, and controls the BS1 and BS2. The MSC 120 can also inquire about the location of the MS1 101 or MS2 102 from a Home Location Register (HLR) 140.

A Short Message Service Center (SMSC) 130 is connected to the HLR 140 and the MSC 120. The SMSC 130 detects the location of the MS1 101 or MS2 102, and transmits the location to a mobile station via an SMS message. If the SMSC 130 is requested to transmit an SMS message to a called mobile station that cannot perform a receiving operation at an arbitrary period of time, it may store the SMS message for a certain period of time and then forward it to the called mobile station later. For example, if an SMS message for a remote control function is transmitted from the MS1 101 or MS2 102 to the BS1 111 or BS2 112, the BS1 111 or BS2 112 receives the SMS message and then transmits it to the MSC 120. The MSC 120 transmits the received SMS message to the SMSC 130. The SMSC 130 determines whether the called terminal that transmitted the SMS message, i.e., the MS1 101 or MS2 102, is in a receivable state. If the called terminal is in a receivable state, the SMSC 130 transmits the received SMS message to the called terminal On the contrary, if the called terminal is in a non-receivable state, the SMSC 130 stores the received SMS message and does not transmit it to the called terminal until the called terminal changes its state into a receivable state. The HLR 140 stores subscriber information, such as locations of mobile station users, etc. In an exemplary embodiment of the present invention, the MS1 101 or MS2 102 is explained based on a mobile communication terminal. However, it should be understood that the present invention is not so limited. For example, the MS1 101 or MS2 102 may be implemented with a Personal Data Assistant (PDA), a smart phone, etc.

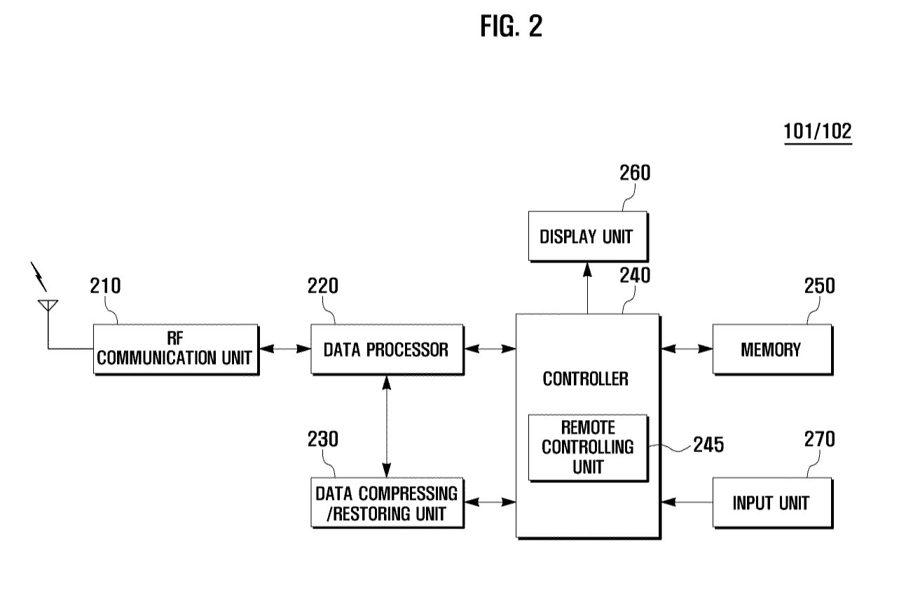

FIG. 2 is a schematic block diagram illustrating a portable terminal for remotely controlling user data, according to an exemplary embodiment of the present invention. As shown in FIG. 2, the portable terminal may be a mobile station, such as the MS1 101 or MS2 102, as shown in FIG. 1.

Referring to FIG. 2, an RF communication unit 210 allows for RF communication between a portable terminal 101 or 102 and the BS1 111 or BS2 112 shown in FIG. 1. The RF communication unit 210 is configured to include an RF transmitter for up-converting the frequency of transmitted signals and amplifying the transmitted signals and an RF receiver for low-noise amplifying received RF signals and down-converting the frequency of the received RF signals.

A data processor 220 processes input data, etc. The data processor 220 includes a transmitter for coding and modulating signals that will be transmitted via the RF communication unit 210 and a receiver for demodulating and decoding signals received by the RF communication unit 210. For example, the data processor 220 may include a MOdulator/DEModulator (MODEM) and a COder/DECoder (CODEC).

A data compressing/restoring unit 230 implements a compression algorithm. Using its compression algorithm, the data compressing/restoring unit 230 compresses data that will be transmitted under the remote control of a remote controlling unit 245 of a controller 240. The data compressing/restoring unit 230 can also decompress the received compressed data and then restore the original data. In particular, the data compressing/restoring unit 230 can exert its capability if the data size is large. If the portable terminal shown in FIG. 2 is implemented with the MS1 101, the data compressing/restoring unit 230 serves as a data compressing unit and compresses data. If the portable terminal shown in FIG. 2 is implemented with the MS2 102, the data compressing/restoring unit 230 serves a data decompressing unit and restores data.

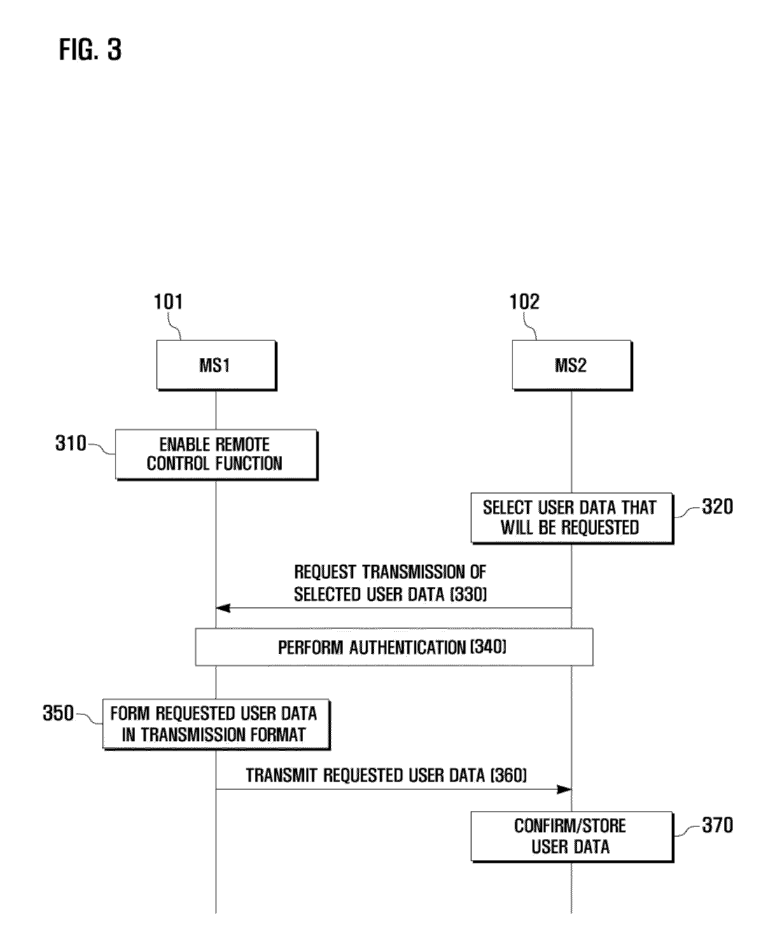

A controller 240 controls operations of the portable terminal 101 or 102 and signal flows between blocks in the portable terminal 101 or 102. The controller 240 may include the data processor 220. The controller 240 may include the remote controlling unit 245 for performing a remote control function. The remote control function will be described in more detail later with reference to FIGS. 3 to 7.

A memory 250 stores application programs necessary for operations of the portable terminal 101 or 102 and a variety of data. For example, the memory 250 may store a phone book, schedule information, a memo, and other data input by a user. The memory 250 may also store user data, such as SMS messages, MMS messages, etc., where the SMS messages and MMS messages are received via the RF communication unit 210, and hereinafter called a message. The memory 250 may further store information regarding a called terminal and a remote controlling password, which are input to set a remote control function.

A display unit 260 displays data, generated while the program is executed, on a screen. The display unit 260 also displays a user's key input states. The display unit 260 may be implemented with an LCD. In particular, if the display unit 260 is implemented with a touch screen, it may also serve as an input device.

An input unit 270 allows a user to input numerical and character information and outputs input signals, related to the setting of a variety of functions and to the control of the portable terminal 101 or 102, to the controller 240. The input unit 270 may be implemented with a touch pad, a keypad, or a combination thereof, according to the type of portable terminal 101 or 102. Although not illustrated in FIG. 2, the portable terminal 101 or 102 may further include an SIM card containing a user's identification information. In that case, the controller 240 determines whether the SIM card has been changed and thus detects whether a loss event occurs.

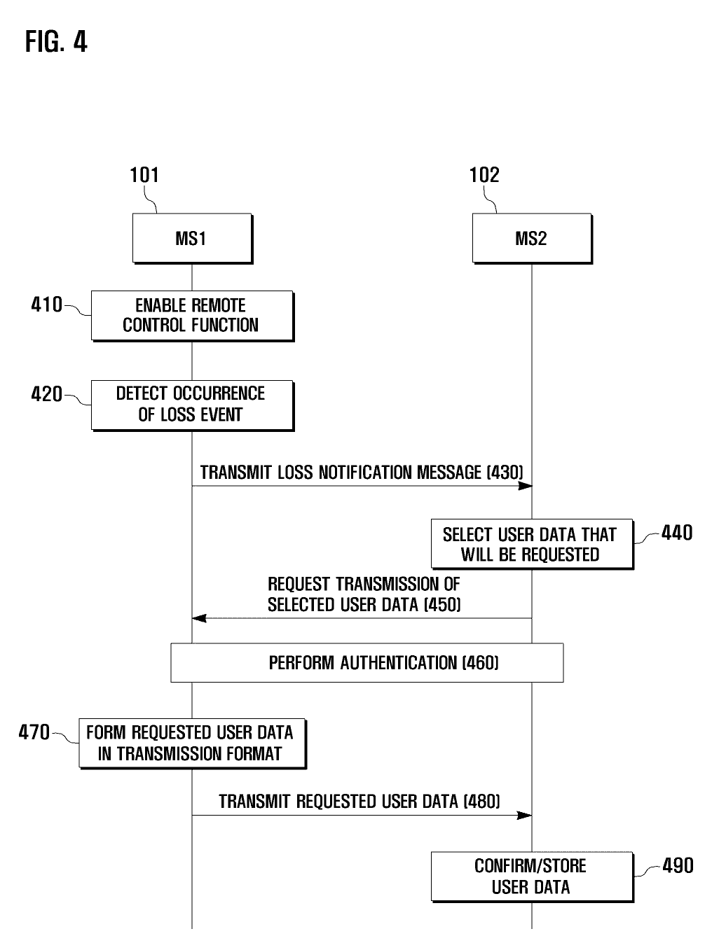

In the following description, a method for remotely controlling user data is described, with respect to respective cases where the user does not carry the portable terminal, with reference to FIG. 3, and where the user has lost the portable terminal with reference to FIG. 4.

FIG. 3 is a signal flowchart describing a method for remotely controlling user data if a user does not carry his/her portable terminal, according to an exemplary embodiment of the present invention.

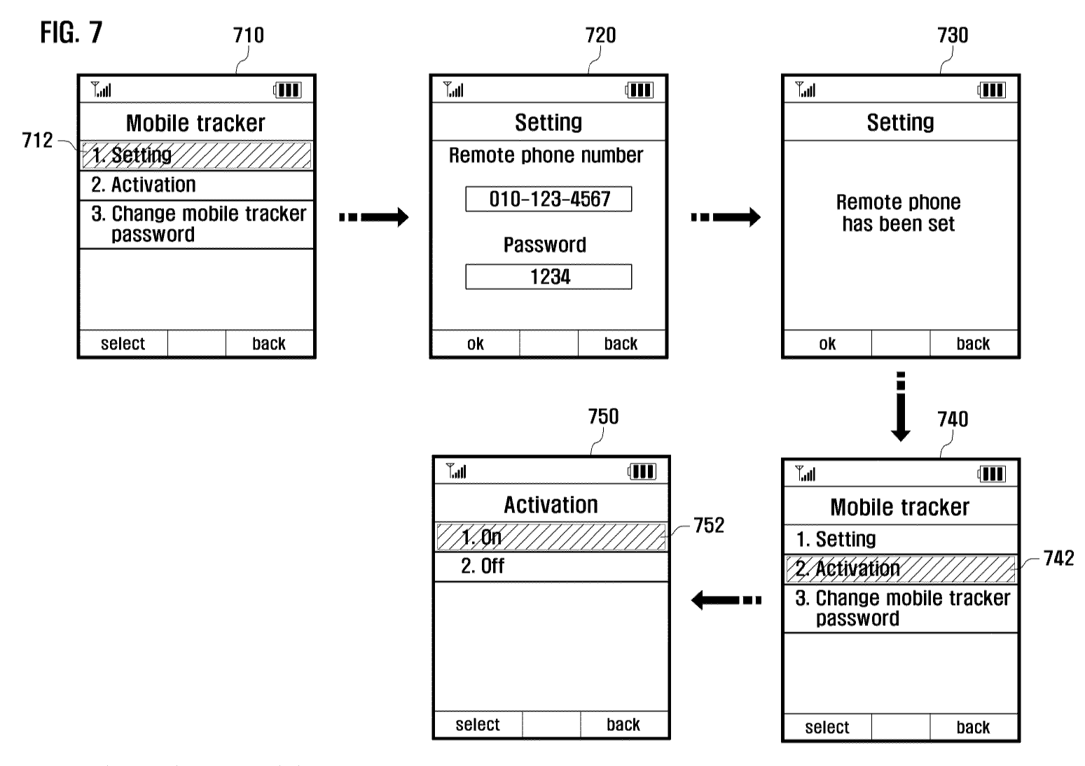

Referring to FIG. 3, it is assumed that the MS1 101 is a slave terminal that has enabled a remote control function and the MS2 102 is a master terminal that remotely controls user data of the MS1 101. That is, the MS1 101 refers to a portable terminal that is remotely controlled by a user and stores user data. The MS2 102 refers to a terminal that is operated by the user to control the MS1 101. In the following description, it is assumed that the MS2 is set as a message receiving terminal that receives a message from the slave terminal that is set with the remote control function. To this end, the MS1 101 can be set with a remote control function, together with setting information regarding the message receiving terminal, such as a phone number and a remote control password for authentication. The process of setting a remote control function will be described in more detail with reference to FIG. 7.

Referring to FIG. 3, the MS1 101 is in a state where a remote control function is activated in step 310. The MS2 102 selects user data to be transmitted from the MS1 101 in order to remotely control user data of the MS1 101 in step 320. The user data can be selected as a user performs an inputting operation via the input unit 270 shown in FIG. 2. The user data contains necessary information for the user of the MS1 101. For example, the user data contains a phone book, schedule information, memo, and messages. The MS2 102 requests a list of user data from the MS1 101 in order to select user data. After receiving a list of corresponding user data from the MS1 101, the MS2 102 may select user data from the received list. The MS2 102 requests transmission of the selected user data from the MS1 101 in step 330. Transmission of user data can be requested by using an SMS message.

The MS1 101 and MS2 102 perform an authentication process 340. During the authentication process, the MS1 101 requests an authentication number, such as a password, from the MS2 102, receives the authentication number, and determines whether the received authentication number is consistent with an authentication number associated with the MS2 102. In an exemplary embodiment, the authentication number may be previously stored. If it is determined that the received authentication number is consistent with the associated authentication number, the MS1 101 performs next processes to transmit user data, requested by the MS2 102, to the MS2 102. On the contrary, if it is determined that the received authentication number is not consistent with the associated authentication number, the MS1 101 transmits a message, indicating that the authentication numbers are inconsistent, to the MS2 102. The process of determining the authentication number from the MS1 101 to the MS2 102 is performed once. It should be understood that the number of times of determining the authentication number may be set at a predetermined frequency. The process of authenticating MS2 102 may be performed at step 330 by determining whether the authentication number contained in the transmitted message is consistent with an associated authentication number, instead of performing the authentication process of step 340. The exemplary embodiment of the present invention shown in FIG. 3 illustrates the case where the authentication numbers are consistent with each other. It should be understood that the MS1 101 may determine whether the received message corresponds to a message for remote control before it performs the authentication process of step 340. In an exemplary embodiment of the present invention, it is assumed that the MS1 101 and MS2 102 can distinguish between a message for remote control and a general SMS message according to a preset protocol.

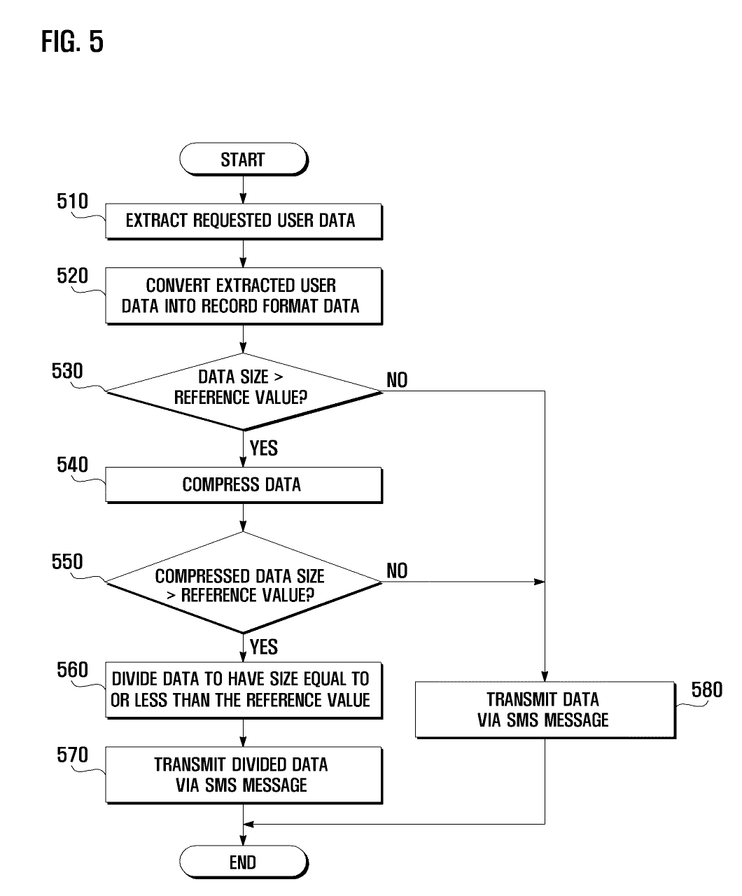

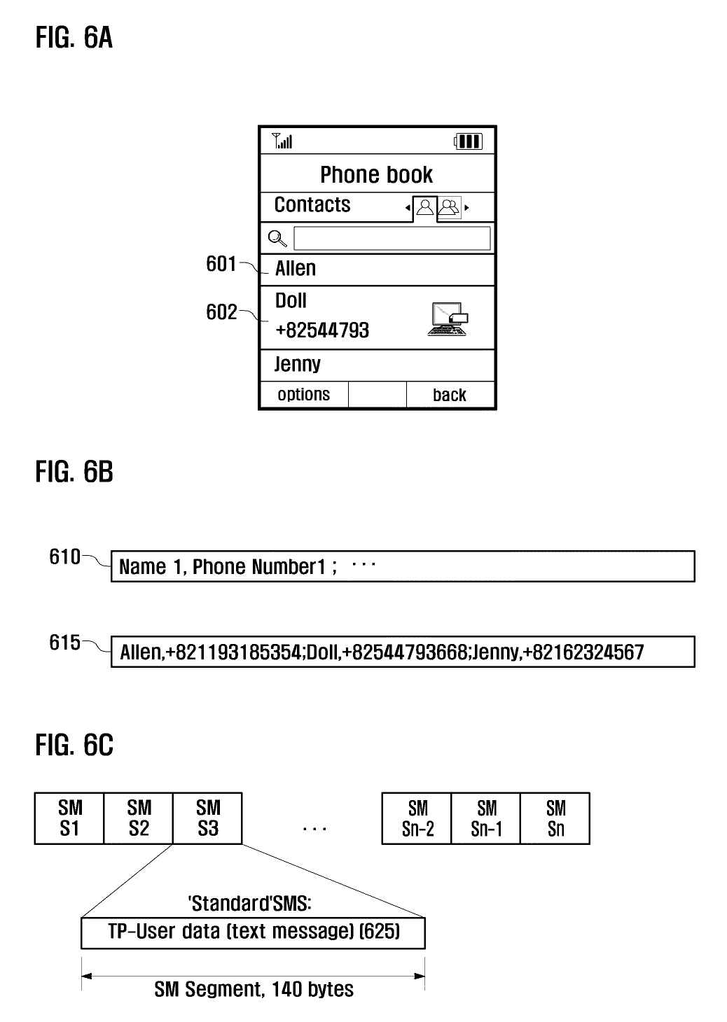

The MS1 101 processes user data, requested by the MS2 102, in a preset format, for example, an SMS message, an MMS, an email, etc. in order to transmit the requested user data to the MS2 102 in step 350. If the requested user data is equal to or greater than a certain size (hereinafter a reference value), the MS1 101 may compress the requested user data using a compression algorithm and then transmit it to the MS2 102. This process will be described in more detail with reference to FIG. 5 and FIGS. 6A to 6C. The MS1 101 transmits the requested user data, processed in a transmission format, to the MS2 102 in step 360. The MS2 102 identifies the received user data and then stores it or terminates the process in step 370.

As described above, although a user does not carry his/her portable terminal, he/she can remotely control the portable terminal and acquire user data therefrom. Therefore, the system according to an exemplary embodiment of the present invention can provide user convenience to portable terminal users.

FIG. 4 is a signal flowchart describing a method for remotely controlling user data if a user lost his/her portable terminal, according to an exemplary embodiment of the present invention.

Referring to FIG. 4, it is assumed that the MS1 101 is a slave terminal that has enabled a remote control function and the MS2 102 is a master terminal that remotely controls user data of the MS1 101. That is, the MS1 101 refers to a portable terminal that is remotely controlled by a user and stores user data. The MS2 102 refers to a terminal that is operated by the user to control the MS1 101. In the following description, it is assumed that the MS2 is set as a message receiving terminal that receives a message from the slave terminal that is set with the remote control function. To this end, the MS1 101 can be set with a remote control function, together with setting information regarding the message receiving terminal, such as a phone number and a remote control password for authentication. The process of setting a remote control function will be described in more detail with reference to FIG. 7.

Referring to FIG. 4, the MS1 101 is in a state where a remote control function is activated in step 410. The MS1 101 continues determining whether a loss event of a portable terminal occurs, while a remote control function is active. If a portable terminal has a SIM card, determining as to whether a loss event of the portable terminal has occurred is achieved by detecting whether the SIM card has been changed. That is, it can be determined that a loss event of a portable terminal has occurred by detecting whether a preset operation is generated. If the MS1 101 detects that a loss event has occurred in step 420, it transmits a message, notifying that a loss event has occurred, to the MS2 102 in step 430. The message has a preset format where the MS2 102 is preset as a called terminal.

When the MS2 102 receives the loss notifying message from the MS1 101, it selects user data to be transmitted from the MS1 101 in order to remotely control user data of the MS1 101 in step 440. The selected user data may contain information as to whether the selected user data is transmitted from the MS1 101 to the MS2 102 and then deleted from the MS1 101. If a selection is made to delete the user data, the MS1 101 transmits the user data to the MS2 102 and then deletes it from its memory 250. In addition, selecting user data can be achieved by a user's input via the input unit 270 shown in FIG. 2. The user data contains necessary data for the user of the MS1 101, for example, a phone book, schedule information, memo and messages. In order to select user data, the MS2 102 requests a list of user data from the MS1 101, receives the list therefrom, and then selects corresponding user data from the received list. The MS2 102 requests transmission of the selected user data from the MS1 101 in step 450. Transmission of user data can be requested by using an SMS message.

The MS1 101 and MS2 102 perform an authentication process in step 460. During the authentication process, the MS1 101 requests an authentication number, such as a password, from the MS2 102, receives the authentication number, and determines whether the received authentication number is consistent with an authentication number associated with the MS2 102. In an exemplary embodiment, the authentication number may be previously stored. If it is determined that the received authentication number is consistent with the associated authentication number, the MS1 101 performs additional processes to transmit user data, requested by the MS2 102, to the MS2 102. On the contrary, if it is determined that the received authentication number is not consistent with the associated authentication number, the MS1 101 transmits a message, indicating that the authentication numbers are inconsistent, to the MS2 102. The process of determining the authentication number from the MS1 101 to the MS2 102 is performed once. It should be understood that the number of times the authentication number is determined may be set at a predetermined frequency. The process of authenticating MS2 102 may be performed at step 450 by determining whether the authentication number contained in the transmitted message is consistent with an associated authentication number, instead of performing the authentication process of step 460. The exemplary embodiment of the present invention shown in FIG. 4 illustrates the case where the authentication numbers are consistent with each other. It should be understood that the MS1 101 may determine whether the received message corresponds to a message for remote control before it performs the authentication process of step 460. In an exemplary embodiment of the present invention, it is assumed that the MS1 101 and MS2 102 can distinguish between a message for remote control and a general SMS message according to a preset protocol.

The MS1 101 processes user data, requested by the MS2 102, in a preset format, for example, an SMS message, an MMS, an email, etc. in order to transmit the requested user data to the MS2 102 in step 470. If the requested user data is equal to or greater than a certain size (hereinafter a reference value), the MS1 101 may compress the requested user data using a compression algorithm and then transmit it to the MS2 102. This process will be described in more detail with reference to FIG. 5 and FIGS. 6A to 6C. The MS1 101 transmits the requested user data, processed in a transmission format, to the MS2 102 in step 480. If a request is made to delete user data from the MS1 101 after the user data is transmitted to the MS2 102, the MS1 101 transmits the user data to the MS2 102 and then deletes it from its memory 250 at step 480. The MS2 102 identifies the received user data and then stores it or terminates the process in step 490.

As described above, although a user loses his/her portable terminal, he/she can remotely control the lost portable terminal That is, the user can receive user data from the lost portable terminal and even delete user data therefrom, thereby preventing his/her information from being disclosed from the lost portable terminal. Furthermore, if the requested user data is large, it can be compressed and then transmitted from the lost portable terminal to a terminal that a user is accessing. That is, the system according to an exemplary embodiment of the present invention can allow for user data transmission, irrespective of the amount of user data, because of the use of a data compressing method. This can allow a user not to suffer from inconvenience where the user requests user data repeatedly and then receives the data from the lost portable terminal.

FIG. 5 is a flowchart describing a method for transmitting user data, according to an exemplary embodiment of the present invention, where the MS1 101, set as a slave terminal, receives a request to transmit user data from the MS2 102 and then transmits the requested user data in an SMS message format to the MS2 102.

FIGS. 6A, 6B and 6C are views illustrating a method for converting user data in a transmission format, according to an exemplary embodiment of the present invention. In an exemplary embodiment of the present invention, the requested user data is a phone book.

Referring to FIG. 5 and FIGS. 6A to 6C, the controller 240, or the remote controlling unit 245, extracts requested user data from the memory 250 in step 510. The user data may be a phone number as shown in FIG. 6A. The remote controlling unit 245 converts the extracted user data, i.e., a phone book, into record format data 610, shown in FIG. 6B in step 520. The record format data 610 is record format raw data composed of text. That is, the record format data 610 may be data stored in the phone book. For example, the record format data 610 may be composed of name 1, phone number 1; name 2, phone number 2; . . . and so on. As shown in FIG. 6A, record format data 610, ‘Allen’ as the first stored name 601, ‘+82 1193185354 ’ of Allen's phone number; and ‘Doll’ as a name 602 next to ‘Allen’, ‘+82544793668 ’ of Doll's phone number, is extracted from the phone book, and then converted into text format data 615.

The remote controlling unit 245 determines whether the size of the converted data is greater than a reference value in step 530. The reference value refers to the maximum amount of data that can be transmitted in a preset transmission format, once. In an exemplary embodiment of the present invention, since the converted data is transmitted in an SMS format, it is assumed that the reference value is 140 bytes allowable in a short message. If it is determined that the size of the converted data is greater than the reference value (i.e., 140 bytes) at step 530, the remote controlling unit 245 compresses the converted data using a compression algorithm implemented in the data compressing/restoring unit 230 in step 540. In an exemplary embodiment of the present invention, the compression algorithm is implemented with a ZIP algorithm, which is a well-known algorithm. A data compressing/restoring unit 230 of the master terminal receives the compressed data and restores it using a decompression algorithm that is substantially the same as the compressing algorithm used by the slave terminal, thereby acquiring the original user data.

The remote controlling unit 245 determines whether the compressed data is greater than a reference value in step 550. The reference value refers to the maximum size of data that can be transmitted in a preset transmission format, once. In an exemplary embodiment of the present invention, since compressed data is transmitted through an SMS, it is assumed that the reference value is 140 bytes allowable in a short message. If it is determined that the size of the compressed data is greater than the reference value (i.e., 140 bytes) at step 550, the remote controlling unit 245 divides the compressed data into data of equal to or less than 140 bytes in step 560. The divided data is shown in FIG. 6C. The divided data is composed of n Short Message (SM) segments, where n is a natural number. One SM segment is composed of a user data field of 140 bytes according to the international standard for SMS message. In FIG. 6C, the user data field is labeled as 625. Each of the divided SM segments is transmitted through one SMS message. The remote controlling unit 245 transmits the data, divided into n SM segments, to a preset called terminal via the RF communication unit 210 in step 570. On the contrary, if it is determined that the size of the converted data is equal to or less than the reference value (i.e., 140 bytes) at step 530, or if it is determined that the size of the compressed data is equal to or less than the reference value (i.e., 140 bytes) at step 550, the remote controlling unit 245 transmits the converted data or compressed data in an SMS message format to a preset called terminal via the RF communication unit 210 in step 580. Referring to FIG. 5, although the exemplary embodiment of the present invention is implemented in such a way that the user data is a phone book and all information is extracted from the phone book and then transmitted, it should be understood that the present invention is not so limited. For example, the invention may be modified in such a way that part of information or particular information is selected and extracted from the phone book and then processed.

As described above, although the amount of user data requested to be transmitted is large, an exemplary system of the present invention can compress and then transmit the data, thereby achieving efficient transmission of user data. This can allow a user to avoid an inconvenience caused when a user must repeatedly request the desired user data. This can also resolve transmission failure due to the large size of requested user data.

FIG. 7 illustrated display screens during a method for setting a remote control function, according to an exemplary embodiment of the present invention.

Referring to FIG. 7, if a remote control function, for example, a mobile tracker function, is selected so that the MS1 101 serving as a slave terminal can be set by the function, the display unit 260 displays the screen 710. When an item 712, ‘Setting’, is selected on the screen 710, the display unit 260 switches the screen 710 to a screen 720 for inputting information regarding a master terminal and a remote control password. When master terminal information, i.e., a remote phone number (phone number of the master terminal), and a remote control password for authenticating the master terminal are input to the screen 720 via the input unit 270, the display unit 260 displays a message indicating that the master terminal has been set for a mobile tracker function, i.e., ‘Remote phone has been set’, on the screen 730, where “remote phone” refers to the master terminal. In an exemplary embodiment of the present invention, the following process may be further included. That is, in order to complete the settings, the MS1 101 transmits a message, indicating that the MS2 102 has been set as a remote portable terminal, to the master terminal, MS2 102, and then receives a response message from the master terminal, MS2 102.

After the MS2 102 has been set as a remote portable terminal shown in screen 730, the display unit 260 switches the screen 730 to a screen 740. When an item 742 ‘Activation’ is selected on the screen 740 via the input unit 270, the display unit 260 switches to a screen 750. When an item 752 ‘On’ for activating a remote control function is selected on the screen 750 via the input unit 270, the remote control function has been set. In an exemplary embodiment of the present invention, the MS1 101 sets the remote control function through the screens shown in FIG. 7. Meanwhile, the states where a remote control function is activated, at step 310 of FIG. 3 and step 410 of FIG. 4, refer to the state that the MS1 101 has been set in a remote control function through the processes of FIG. 7 and then is showing the screen 750 where the remote control function is activated.

As described above, since a preset terminal can remotely control a portable terminal where user data is stored, the system according to an exemplary embodiment of the present invention can provide enhanced convenience to the users. If a large amount of user data is requested to be transmitted according to the remote control, the system can compress and then transmit the user data from the portable terminal to the terminal that the user can access, with only one user's request. Since the system according to exemplary embodiments of the present invention can remotely access a portable terminal through authentication and control user data, such as personal information, stored therein, it can prevent the user data from being disclosed from the lost portable terminal.

While the invention has been shown and described with reference to certain exemplary embodiments thereof, it will be understood by those skilled in the art that various changes in form and details may be made therein without departing from the scope and spirit of the invention as described in the appended claims and their equivalents.

What is claimed is:

1. A method for remotely controlling user data, the method comprising:
setting a remote control function in a slave terminal;
requesting, by a master terminal, user data stored in the slave terminal from the slave terminal;
authenticating, by the slave terminal, the master terminal;
compressing, by the slave terminal, the user data requested by the master terminal, according to the size of the user data; and
transmitting the compressed user data to the master terminal if the master terminal has been authenticated.

2. The method of claim 1, wherein the transmitting of the compressed user data further comprises:
extracting the requested user data from a memory; and
converting the extracted user data into data of a record format.

3. The method of claim 2, wherein the converted data is transmitted in at least one of a Short Message Service (SMS) message format, a Multimedia Messaging Service (MMS) message format, and an email format.

4. The method of claim 2, wherein the compressing of the user data comprises:
comparing the size of the converted data with a reference size; and
compressing, if the size of the converted data is greater than the reference size, the converted data by a compression algorithm.

5. The method of claim 4, further comprising:
compressing the converted data;
comparing the size of the compressed data with the reference size; and
dividing, if the size of the compressed data is greater than the reference size, the compressed data into the reference size.

6. The method of claim 1, wherein the user data comprises:
at least one of a phone book, schedule information, an SMS message, an MMS message, and a memo.

7. The method of claim 1, wherein the setting of the remote control function in the slave terminal comprises;
storing information regarding the master terminal and a remote control password in the slave terminal; and
activating the remote control function.

8. The method of claim 7, wherein the remote control function is a mobile tracker.

9. The method of claim 7, wherein the authenticating of the master terminal comprises determining whether the stored remote control password is consistent with a password that is provided from the master terminal when the master terminal requests the user data from the slave terminal.

10. The method of claim 1, further comprising:
detecting a loss event at the slave terminal; and
transmitting a loss notification message to the master terminal,
wherein the detecting of the loss event comprises determining if a Subscriber Identity Module (SIM) card has been changed.

11. A system for remotely controlling user data, the system comprising:
a slave terminal, set in a remote control function, for storing user data; and
a master terminal for requesting the user data from the slave terminal and receiving it,
wherein the slave terminal authenticates the master terminal when the master terminal requests the user data therefrom, compresses the requested user data, according to the size of the user data, during the authentication, and transmits the compressed user data to the master terminal.

12. The system of claim 11, wherein the slave terminal comprises:
a memory for storing the user data, information regarding the master terminal, and a remote control password;
a remote controlling unit for extracting the requested user data when the authenticated master terminal requests transmission of the user data from the slave terminal, wherein the master terminal is authenticated by the stored remote control password;
a compressing unit for compressing the user data at the slave terminal by a compressing algorithm if the size of the user data is greater than a reference size; and
an RF communication unit for transmitting the user data to the master terminal.

13. The system of claim 12, wherein the remote controlling unit converts the extracted user data into data of a record format and generates data in at least one of a Short Message Service (SMS) message format, a Multimedia Messaging Service (MMS) message format, and an email format.

14. The system of claim 13, wherein the remote controlling unit compares the size of the compressed data with the reference size, and divides the compressed data into the reference size if the size of the compressed data is greater than the reference size.

15. The system of claim 11, wherein the user data comprises:
at least one of a phone book, schedule information, an SMS message, an MMS messages, and a memo.

16. The system of claim 12, wherein the remote controlling unit authenticates the master terminal if the stored remote control password is consistent with a password that is provided from the master terminal when the master terminal requests the user data from the slave terminal.

17. The system of claim 11, wherein the remote control function is a mobile tracker that is installed in the slave terminal and the master terminal.

18. The system of claim 12, wherein the remote controlling unit transmits the user data to the master terminal and then deletes the user data from the memory if a request is made to transmit and delete the user data.

19. The system of claim 11, wherein the slave terminal detects a loss event and transmits a loss notification message to the master terminal,
wherein the slave terminal detects of the loss event by determining if a Subscriber Identity Module (SIM) card has been changed.
